(19) United States
(12) Patent Application Publication
(10) Pub. No.: US 2002/0192530 A1
(43) Pub. Date: Dec. 19, 2002

(54) Fuel cell that can stably generate electricity with excellent characteristics

(76) Inventors: Hiroki Kabumoto, Ashford, CT (US); Yoshito Chikano, Gunma (JP); Ikuo Yonezu, Osaka (JP); Takahiro Isono, Osaka (JP); Takashi Yasuo, Tochigi (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/088,515

(22) PCT Filed: Aug. 13, 2001
(86) PCT No.: PCT/JP01/06964

(30) Foreign Application Priority Data
Aug. 11, 2000 (JP) 2000-244960
Oct. 23, 2000 (JP) 2000-322568

(51) Int. Cl. H01M 4/94; H01M 8/10; H01M 4/96; H01M 8/02

(52) U.S. Cl. 429/38; 429/44; 429/30; 429/42

(57) ABSTRACT

To provide a fuel cell that includes a cell unit formed by arranging an anode and a cathode on a proton exchange membrane and that can stably generate electricity with excellent characteristics. To realize such a fuel cell, wettability of the proton exchange membrane and the electrode catalyst layer is made uniform. In a gas diffusion layer 24 sandwiched between a cathode catalyst layer 22 and a cathode side separator plate 60, water retentivity in a predetermined range from an inlet for an oxidizing gas (air) is adjusted so as to be higher in parts 24A that face oxidant channels 65 than in parts 24B that face ribs 66. This wettability adjustment in the gas diffusion layer 24 is accomplished by setting water repellent material content per unit area in the channel facing parts 24A smaller than in the rib facing parts 24B.

### TECHNICAL FIELD

The present invention relates to a fuel cell that uses a proton exchange membrane as an electrolyte membrane.

### BACKGROUND ART

There are several different types of fuel cells, such as phosphoric-acid fuel cells and molten carbonate fuel cells, which are classified by the type of electrolyte they use. In recent years, fuel cells that use a proton exchange membrane of positive-ion conversion type as an electrolyte membrane have actively been developed. Such proton exchange membrane fuel cells can generate electricity with high performances at relatively low operating temperatures.

A fuel cell of this type has the following basic structure. A cell unit is constructed by a proton exchange membrane on one surface of which a cathode is arranged and on the other surface of which an anode is arranged. This cell unit is sandwiched between a pair of plates each having gas channels and ribs formed between adjacent gas channels. For practical use, a fuel cell is composed of a number of such cell units placed one on top of another, so that high output can be obtained.

Each of the cathode and the anode is typically composed of an electrode catalyst layer arranged on a proton exchange membrane, and a gas diffusion layer arranged thereon so as to cover the electrode catalyst layer. The gas diffusion layer, as being interposed between the electrode catalyst layer and the gas channels, enables a gas flowing on the gas channels to be diffused throughout the electrode catalyst layer, and also ensures conductivity between the electrode catalyst layer and the ribs on the plate.

Because ionic conductivity of the proton exchange membrane and the electrode catalyst layer is low in a dry environment, a fuel cell is typically operated with the proton exchange membrane being humid by supplying a pre-humidified fuel gas and oxidizing gas. In recent years, however, demands for more compact fuel cell systems have emerged. To meet the demands, a fuel cell of different type has been developed, to which air without being humidified is supplied as an oxidizing gas.

To enable such a fuel cell to generate electricity with high performances, it is preferable to uniformly humidify the entire proton exchange membrane or the entire electrode catalyst layer. This is due to the following reason. If wettability of the proton exchange membrane or of the electrode catalyst layer varies depending on its parts, such that one part is insufficiently humidified and another part is excessively humidified, the part with insufficient water content suffers from inferior ionic conductivity, and the part with excessive water content suffers from inferior gas diffusibility in the electrode catalyst layer. If this happens, the fuel cell is unable to exhibit excellent electricity generation performances.

In reality, however, water content is more liable to decrease due to evaporation into an oxidizing gas, in such a region of the proton exchange membrane or of the electrode catalyst layer that is in the vicinity of an oxidizing gas inlet (at the air inlet side) than in an oxidizing gas outlet side region. Therefore, the tendency is that the proton exchange membrane and the electrode catalyst may often suffer from insufficient water content.

Further, water content is more liable to decrease due to evaporation into an oxidizing gas, in parts facing the oxidizing gas channels than in parts facing the ribs. Again, the tendency is that the proton exchange membrane and the electrode catalyst layer may often suffer from insufficient water content.

In fuel cells that generate electricity when supplied with an oxidizing gas (air) that has not been humidified, therefore, a proton exchange membrane and an electrode catalyst are liable to have uneven wettability.

This problem is addressed, for example, by a technique disclosed in Japanese published unexamined application H11-154523. This publication proposes a cell unit for use in a proton exchange membrane fuel cell. The cell unit is constructed in such a manner that a region of the cathode gas diffusion layer and/or of the anode gas diffusion layer that is close to the gas inlet side has smaller gas permeability than a region close to the gas outlet side.

According to this technique, for example, in a cell unit 400 constructed by arranging a cathode 410 and an anode 420 on a proton exchange membrane 401 shown in FIGS. 11A and 11B, an oxidizing gas flows along the cathode 410 (white arrow 431), and a fuel gas flows along the anode 420 (white arrow 432), so as to generate electricity. Here, in the cathode 410, gas diffusibility of a gas diffusion layer is adjusted to be smaller in its region that is close to the gas inlet side (an inlet region 411) than in its region that is close to the gas outlet side (an outlet region 412).

This gas diffusibility adjustment is specifically accomplished by changing a thickness or a porosity of the gas diffusion layer. To be more specific, in the inlet region 411 of the gas diffusion layer, the porosity may be decreased or the thickness may be increased, so as to decrease the gas diffusibility. In the outlet region 412 of the gas diffusion layer, the porosity may be increased or the thickness may be decreased, so as to increase the gas diffusibility.

According to this technique, the oxidizing gas inlet side of the proton exchange membrane 401 can be prevented from drying and the wettability can be made uniform throughout the oxidizing gas inlet side and the oxidizing gas outlet side of the proton exchange membrane 401. However, the problem still lies in uneven wettability in the parts facing oxidizing gas channels and the parts facing ribs. This problem needs to be addressed to improve performances of fuel cells.

Also, when the technique for adjusting gas diffusibility depending on regions is employed as described above, the problem is that an oxidizing gas may not be diffused equally throughout the entire cathode. This may increase concentration polarization at the electrode reaction, causing the output to decrease.

### DISCLOSURE OF THE INVENTION

The object of the present invention is to provide a fuel cell that includes a cell unit formed by arranging an anode and a cathode on a proton exchange membrane and that can stably generate electricity with excellent characteristics, by making wettability of the proton exchange membrane and an electrode catalyst layer uniform.

To achieve the above object, in a fuel cell that includes a cell unit formed by arranging an anode and a cathode on a proton exchange membrane, at least one of (a) a gas diffusion layer interposed between a cathode catalyst layer and a cathode side plate and (b) the cathode catalyst layer is constructed in such a manner that water retentivity is higher in its parts facing oxidant channels than in its parts facing ribs.

Here, “water retentivity of a layer” refers to an amount of water per unit volume that can be retained in the layer. The larger the amount, the higher the water retentivity of the layer.

Such water retentivity adjustment of the cathode side gas diffusion layer or the cathode catalyst layer can decrease the tendency that parts of the proton exchange membrane or the electrode catalyst layer that face the oxidant channels are more liable to dry than parts of the proton exchange membrane or the electrode catalyst layer that face the ribs. Therefore, the proton exchange membrane or the electrode catalyst layer can be uniformly humidified.

Here, the water retentivity adjustment of the gas diffusion layer is particularly effective at least in an oxidant inlet side region. This is due to the following reason. In the oxidant inlet side region, water content in an oxidizing gas is small, and therefore, water is more liable to be diffused from the gas diffusion layer into the oxidizing gas. Accordingly, wettability of the proton exchange membrane and the electrode layer is liable to be uneven in the parts facing the oxidant channels and the parts facing the ribs.

To produce the effect of providing uniform wettability, it is also preferable to perform the above water retentivity adjustment in a predetermined range from an oxidant inlet side end toward an oxidant outlet side within the gas diffusion layer (preferably in a range of 10% to 90% of the entire region between the oxidant inlet side end and the oxidant outlet side end within the gas diffusion layer).

Such water retentivity adjustment in the gas diffusion layer can be accomplished by forming the gas diffusion layer from a conductive substrate containing a water repellent material, and by setting the water repellent material content smaller in its parts facing the oxidant channels than in its parts facing the ribs.

Alternatively, the above water retentivity adjustment can be accomplished by applying a mixture of carbon particles and a water repellent material on the gas diffusion layer so as to form a water retentivity adjustment layer, and by adjusting water retentivity of the water retentivity adjustment layer.

Such water retentivity adjustment in the water retentivity adjustment layer can be accomplished, for example, by using carbon particles with higher water retentivity (with a larger specific surface) in the parts facing the oxidant channels than carbon particles used in the parts facing the ribs.

Also, to adjust water retentivity of the cathode side gas diffusion layer and the cathode catalyst layer as described above, the gas diffusion layer and an intermediate water retentive layer that contains an ion exchanger may be interposed between the cathode catalyst layer and the second plate, the gas diffusion layer being arranged at the second plate side, and the intermediate water retentive layer being arranged at the cathode catalyst layer side, and water retentivity of the intermediate water retentive layer may be adjusted to be higher in its parts facing the oxidant channels than in its parts facing the ribs.

It should be noted even though the above-described water retentivity adjustment in the gas diffusion layer and the cathode catalyst layer, or the above-described provision of the intermediate water retentive layer is performed, gas diffusibility of the entire layer can be ensured and an oxidant can be diffused equally throughout electrodes.

According to the present invention, therefore, wettability and gas diffusibility can be ensured throughout the entire proton exchange membrane and the entire electrode catalyst layer, and therefore enables a fuel cell to generate electricity with high performances.

The present invention produces substantial effects, particularly when applied to a fuel cell that generates electricity by supplying an oxidizing gas (air) without being humidified to a cathode.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is an exploded view of a cell unit that constitutes a proton exchange membrane fuel cell relating to a first embodiment of the present invention;

FIG. 2 shows the construction of a fuel cell stack relating to embodiments of the present invention;

FIG. 3 is a schematic cross section showing the construction of the cell unit relating to the first embodiment;

FIG. 4 is a characteristic diagram showing a cell voltage measurement value of each cell relating to practical example 1;

FIG. 5 is a cross section showing the construction of a cell unit relating to a second embodiment of the present invention;

FIG. 6 is a characteristic diagram showing a cell voltage measurement value of each cell relating to practical example 2;

FIG. 7 is a characteristic diagram showing a cell voltage measurement value of each cell relating to practical example 3;

FIG. 8 is a cross section showing the construction of a cell unit relating to a fourth embodiment of the present invention;

FIG. 9 is a characteristic diagram showing a cell voltage measurement value of each cell of comparative example relating to practical example 4;

FIG. 10 is a schematic cross section showing the construction of a cell unit for use in a fuel cell relating to a fifth embodiment of the present invention; and

FIGS. 11A and 11B show an example of a fuel cell relating to a conventional technique.

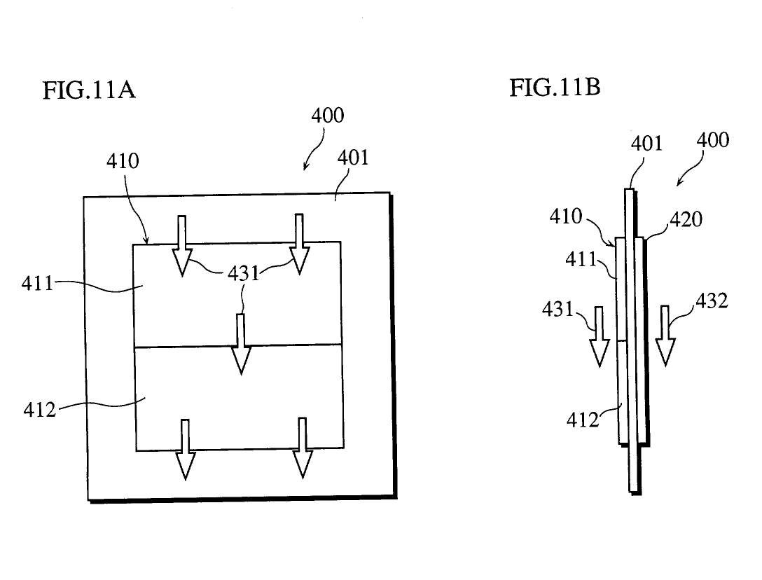

### BEST MODE FOR CARRYING OUT THE INVENTION

[First Embodiment]

The following describes firstly the basic construction of a proton exchange membrane fuel cell, and then the cell construction in detail.

<Overall Construction and Operation of Fuel Cell System>

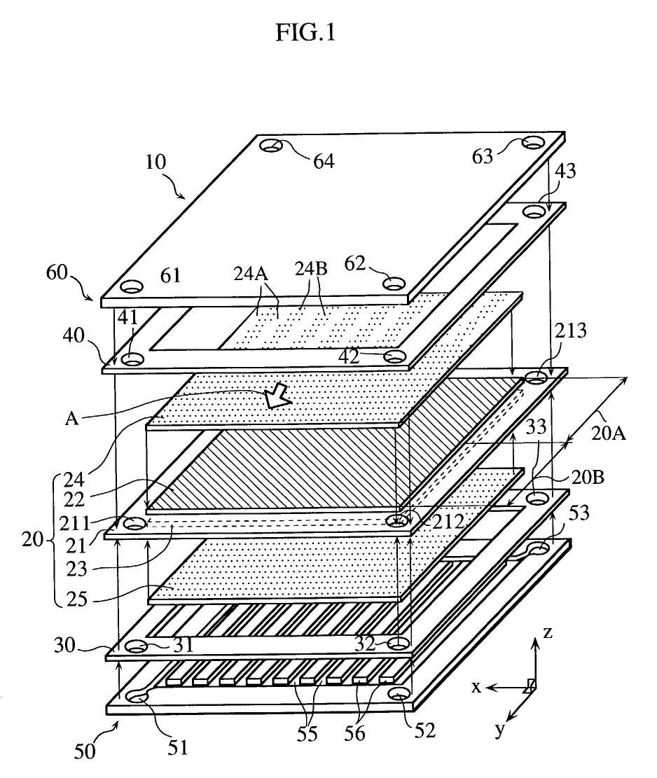

FIG. 1 is an exploded view of a cell unit 10 that constitutes a proton exchange membrane fuel cell to which the first embodiment of the present invention relates.

As the figure shows, the cell unit 10 is roughly constructed by a membrane/electrode assembly 20 sandwiched between a cathode side separator plate 60 and an anode side separator plate 50.

The membrane/electrode assembly 20 is constructed by arranging a cathode on one surface of a proton exchange membrane 21 and an anode on the other surface of the proton exchange membrane 21.

The cathode is composed of a cathode catalyst layer 22 formed on the proton exchange membrane 21 and a gas diffusion layer 24 arranged on the cathode catalyst layer 22. The anode is composed of an anode catalyst layer 23 formed on the proton exchange membrane 21 and a gas diffusion layer 25 arranged on the anode catalyst layer 23.

Accordingly, the gas diffusion layer 24 is being interposed between the cathode catalyst layer 22 and the cathode side separator plate 60 and the gas diffusion layer 25 is being interposed between the anode catalyst layer 23 and the anode side separator plate 50.

The proton exchange membrane 21 is an electrolyte film that is made of a perfluoro carbon sulfonic acid.

The cathode catalyst layer 22 and the anode catalyst layer 23 are films made of carbon particles that support a platinum catalyst to which an ion exchanger (Nafion manufactured by Du Pont, the same is used hereafter) and a water repellent resin are added. The cathode catalyst layer 22 and the anode catalyst layer 23 each are hermetically attached to a main surface of the proton exchange membrane 21 excluding its peripheral part, via hot pressing. A Pt catalyst, a Pt—Ru catalyst, or the like is used as a platinum catalyst. The Pt catalyst exhibits a favorable catalyst action when pure hydrogen is used as a fuel gas, whereas it can be poisoned and exhibits a poor catalyst action when carbon monoxide (CO) is contained in a fuel gas. On the other hand, the Pt—Ru is less liable to be poisoned by CO.

In FIG. 1, the anode catalyst layer 23 is shown by a broken line as it is provided on the lower surface of the proton exchange membrane 21.

The gas diffusion layers 24 and 25, also referred to as current collectors, are layers made of a conductive gas-permeable material. The gas diffusion layers 24 and 25 each are formed by a conductive porous material, such as carbon paper, to which a water repellent material is added to ensure the gas diffusibility. Here, carbon paper filled with a fluorocarbon resin as a water repellent material is assumed to be used, but carbon paper that has been subjected to a water repellent treatment and filled with carbon particles may instead be used.

The anode side separator plate 50 is formed by spouting and forming a mixture of a phenolic resin and carbon particles. On a surface of the anode side separator plate 50 that faces the gas diffusion layer 25 (shown below in FIG. 1), channels 55 that allow a fuel gas (a hydrogen-rich reformed gas) to flow in direction “y” in the figure are formed, and also, ribs 56 are formed between adjacent channels 55.

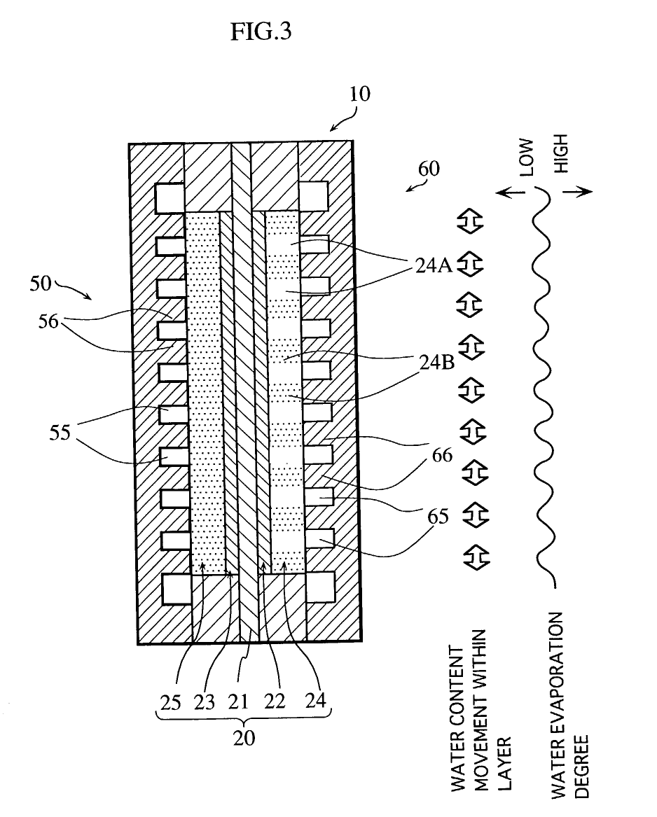

The cathode side separator plate 60 is made of substantially the same material as that for the anode side separator plate 50. Though not being shown in this figure, oxidant channels 65 that allow an oxidizing gas (air) to flow in direction “y” in the figure (a large arrow “A” in the figure) and ribs 66 (see FIG. 3) are formed on the cathode side separator plate 60.

Further, holes 61 to 64, 41 to 44, 211 to 214, 31 to 34, and 51 to 54 (44, 214, 34, 54 are not shown in the figure) are formed at four corners respectively of the proton exchange membrane 21, a gasket 30, a gasket 40, the anode side separator plate 50, and the cathode side separator plate 60.

Among these, the holes 53, 33, 213, 43, and 63 form manifolds to supply a fuel gas to the channels 55 of the anode side separator plate 50, and the holes 51, 31, 211, 41, and 61 form manifolds to discharge the fuel gas. On the other hand, the holes 54, 34, 214, 44, and 64 are manifolds to supply an oxidizing gas to the channels of the cathode side separator plate 60, and the holes 52, 32, 212, 42, and 62 are manifolds to discharge the oxidizing gas.

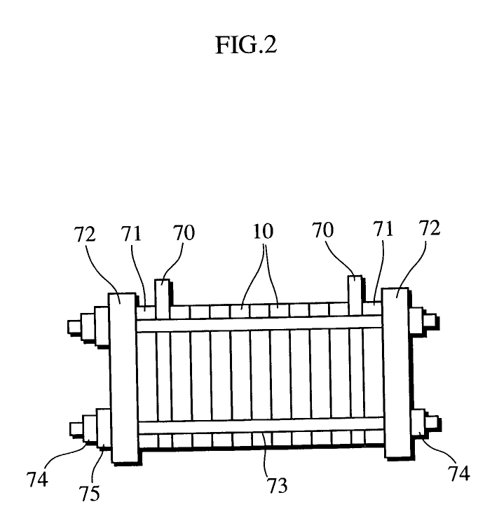

For practical use, a fuel cell stack is formed to enable high voltage and high power to be obtained as shown in FIG. 2. In detail, a number of cell units 10 with the construction described above are stacked up, and these cell units 10 are supported between collector plates 70, insulator plates 71 for insulating electricity and heat, and fastening plates 72 for applying load to hold this stack structure. This stack structure is then clamped with bolts 73 and nuts 74. Note that the clamping load is applied by disc springs 75.

When this fuel cell stack is operated, one or both of a fuel gas and air is humidified and then supplied to respective channels, and the fuel gas and the air are used to generate electricity in the following way.

The fuel gas supplied to the channels 55 is supplied to the anode catalyst layer 23 via the gas diffusion layer 25. Within the anode catalyst layer 23, hydrogen in the fuel gas is then ionized to release electrons (H²→2H⁺+2e⁻). Protons generated here move toward the cathode catalyst layer 22 side within the proton exchange membrane 21. Along with this movement of protons, water content in the anode catalyst layer 23 also moves toward the cathode catalyst layer 23 side.

On the other hand, air is supplied to the cathode catalyst layer 22 side via the gas diffusion layer 24. Within the gas diffusion layer 24, oxygen in the air is bonded to the protons moving thereto within the proton exchange membrane 21, so as to generate water (½O₂+2e⁻+2H⁺→H₂O). Due to the above humidifying water or generated water, the membrane/electrode assembly 20 (particularly the proton exchange membrane 21 and the cathode catalyst layer 22) is humidified. However, the membrane/electrode assembly 20 (particularly the proton exchange membrane 21 and the cathode catalyst layer 22) releases evaporated water into the air flowing through the oxidant channels 65.

<Detailed Description of Cell Construction>

The following describes in detail the construction and the effects of the membrane/electrode assembly 20.

The gas diffusion layer 24, sandwiched between the cathode catalyst layer 22 and the cathode side separator plate 60, is constructed in such a manner that water retentivity is adjusted in a predetermined region (20A in the figure) from the inlet side (the hole 64 side) of an oxidizing gas (air) in the following way. In the predetermined region, water retentivity is adjusted to be higher in parts facing the oxidant channels 65 (referred to as “channel facing parts 24A”) than in parts facing the ribs 66 (referred to as “rib facing parts 24B”).

This water retentivity adjustment in the gas diffusion layer 24 is specifically accomplished by setting the water repellent material content per unit area smaller in the channel facing parts 24A than in the rib facing parts 24B.

Here, it is preferable to set the ratio (Xa/Xb) of the water repellent material content (Xa) per unit area in the channel facing parts 24A with respect to the water repellent material content (Xb) per unit area in the rib facing parts 24B in a range of 0.2 to 0.9 inclusive. The reason for this is described later in practical example 1.

FIG. 3 is a schematic cross section of the cell unit 10 in the air inlet side region 20A, taken in the thickness direction thereof (x-z plane in FIG. 1).

By adjusting the water retentivity in the gas diffusion layer 24 as described above, the following effects can be produced.

Because air flows along the surface of the channel facing parts 24A, water content in the gas diffusion layer 24 is more liable to decrease due to evaporation into the air in the channel facing parts 24A than in the rib facing parts 24B, as indicated by a graph showing water evaporation degree in FIG. 3. In particular, air flowing through the oxidant channels 65 is drier in the air inlet side region 20A than in the air outlet side region 20B. Therefore, more water content tends to be lost in the channel facing parts 24A due to evaporation. Note that this tendency is remarkable particularly when air without being humidified is supplied to the oxidant channels 65.

Taking this into consideration, the present cell unit 10 is constructed in the following way. The gas diffusion layer 24 is constructed in such a manner that water retentivity is higher in the channel facing parts 24A than in the rib facing parts 24B in the air inlet side region 20A. Therefore, the gas diffusion layer 24 creates the force to move water content therein from the rib facing parts 24B toward the channel facing parts 24A as indicated by white arrows in FIG. 3. This enables water content to be supplemented from the rib facing parts 24B to the channel facing parts 24A.

Accordingly, the tendency that the parts of the proton exchange membrane and the cathode catalyst layer facing the oxidant channels 65 are more liable to dry can be decreased. This allows the wettability of the parts facing the oxidant channels 65 and the parts facing the ribs 66 in the membrane/electrode assembly 20 to be made uniform.

In general, air flowing through the oxidant channels 65 increases its water content to a substantial degree by the time it reaches the air outlet side region 20B, after passing through the air inlet side region 20A. Therefore, the difference in water evaporation degree between the channel facing parts 24A and the rib facing parts 24B is relatively small. Accordingly, if the water retentivity is adjusted in the air outlet side region 20B in the same way as in the air inlet side region 20A, the channel facing parts 24A might contrary be more humid than the rib facing parts 24B.

Taking this into consideration to provide uniform wettability throughout the gas diffusion layer 24, it is preferable to adjust the water retentivity only in the air inlet side region 20A as described above. Also, it is preferable to set the size of the air inlet side region 20A where water retentivity is to be adjusted, in a range of 10 to 90% inclusive of the size of the entire gas diffusion layer 24.

However, there are cases where air flowing through the oxidant channels 65 is extremely dry even in the air outlet vicinity, for example, when air without being humidified is supplied. In such a case, it is considered preferable to adjust the water retentivity throughout the entire gas diffusion layer 24.

Also, the water retentivity being adjusted depending on regions of the gas diffusion layer 24 does not have much effect on its gas diffusibility. Therefore, the gas diffusibility can be maintained uniform in the entire reaction region of the gas diffusion layer 24. Accordingly, electricity can be stably generated with an excellent cell voltage.

### PRACTICAL EXAMPLE 1

Based upon the above first embodiment, cells (cell units) 1 to 5 of practical examples, and cells 6 and 7 of comparative examples were produced according to the following specification, and the cell voltage measuring experiment was carried out on each cell.

TABLE 1

| | PTFE Content in Gas Diffusion Layer | | |
|---|---|---|---|
| | Channel Facing Part | Rib Facing Part | PTFE Content Ratio |
| | Xa | Xb | Xa/Xb |
| Cell 1 | 4 | 30 | 0.13 |
| Cell 2 | 6 | 30 | 0.20 |
| Cell 3 | 10 | 30 | 0.33 |
| Cell 4 | 17 | 30 | 0.57 |
| Cell 5 | 25 | 30 | 0.83 |
| Cell 6 | 30 | 30 | 1.00 |
| Cell 7 | 40 | 30 | 1.33 |

Proton exchange membrane:

Perfluoro carbon sulfonic acid film (Nafion: 112 films, size: 12*12 cm, thickness: 50 μm)

Cathode catalyst layer 22 and anode catalyst layer 23:

size: 10*10 cm, thickness: 20 μm

Gas diffusion layer (cathode and anode):

Carbon paper was filled with polytetrafluoroethylene (PTFE) as a water repellent material, so as to have a size of 10*10 cm and a thickness of 200 μm.

For cells 1 to 5, in the air inlet side region of the cathode side gas diffusion layer (50% of the entire region), the PTFE content Xa in the channel facing parts 24A was set relatively small (4, 6, 10, 17, and 25 wt %) as compared with the PTFE content Xb in the rib facing parts 24B (30 wt %) as shown in Table 1.

In the air outlet side region in the cathode side gas diffusion layer, the PTFE content was uniformly set at 30 wt %.

For each cell, the PTFE content in the anode side gas diffusion layer was uniformly set at 30 wt % throughout its entire region.

Cells 6 and 7 of comparative examples were produced in the same manner as cells 1 to 5 of practical examples except that the fluorocarbon fiber content in the channel facing parts 24A of the cathode side gas diffusion layer of cells 6 and 7 was respectively set at 30 and 40 wt %.

The following describes a method for producing each cell in detail.

Cathode side gas diffusion layer: carbon paper (thickness: 200 μm) was prepared, immersed in a PTFE dispersion solution, and baked for one hour at 380° C. The PTFE content at this point was adjusted to be a predetermined value (4 wt % for cell 1, 6 wt % for cell 2, 10 wt % for cell 3, 17 wt % for cell 4, and 25 wt % for cell 5) uniformly in the entire region.

A masking sheet was placed only on parts corresponding to the channel facing parts 24A in the air inlet side region of the layer. A PTFE dispersion solution was sprayed and applied thereon. Then, the layer was baked again for one hour at 380° C.

Here, the applied amount of the PTFE dispersion solution was adjusted in such a manner that the PTFE content was 30 wt % in parts other than the channel facing parts 24A in the air inlet side region.

As described above, cathode side gas diffusion layers for cells 1 to 5 were formed.

A cathode side gas diffusion layer for cell 6 was formed in the following way. Carbon paper was immersed in a PTFE dispersion solution and then baked for one hour at 380° C.

A cathode side gas diffusion layer for cell 7 was formed in the same manner as that for cell 6, and further, a masking sheet having apertures corresponding to the channel facing parts 24A in the air inlet side region was placed on the layer, and the PTFE dispersion solution was sprayed and applied thereon. Then, the layer was baked again for one hour at 380° C.

Here, the applied amount of the PTFE dispersion solution was adjusted in such a manner that the PTFE content was 40 wt % in the channel facing parts 24A in the air inlet side region.

The following processes are common to cells 1 to 7.

Anode side gas diffusion layer: carbon paper (thickness: 200 μm) was prepared, immersed in a PTFE dispersion solution, and baked for one hour at 380° C. Due to this, an anode side gas diffusion layer with the PTFE content of 30 wt % was formed.

Cathode catalyst layer and anode catalyst layer: Pt support carbon particles, a Nafion solution, and a PTFE dispersion solution were mixed at a weight ratio of Pt support carbon particles:Nafion:PTFE as 100:20:10, to form a slurry. This slurry was applied on each of the above formed gas diffusion layers so as to have a thickness of 20 μm, to form a cathode catalyst layer and an anode catalyst layer.

The gas diffusion layers (anode and cathode) on each of which a catalyst layer is formed were arranged one on top of the other with a proton exchange membrane being interposed therebetween, and subjected to hot pressing for 60 sec. at 150° C., to complete each of cells 1 to 7.

(Cell Voltage Measuring Experiment)

Cells 1 to 7 of practical examples and comparative examples produced as described above were operated under the following conditions, and the cell voltage (a value of stable voltage) was measured.

Current Density: 0.5A/cm²

Operating Temperature within Cell: 80° C.

Fuel Gas: pure hydrogen

Oxidizing Gas: air

Fuel Gas Utilization Ratio: 70%

Oxidizing Gas Utilization Ratio: 40%

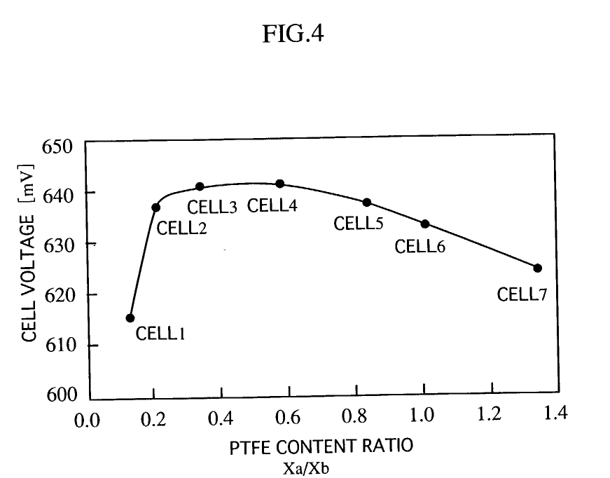

FIG. 4 shows the cell voltage measurement value of each cell, and is a characteristic diagram showing the relationship between (a) the ratio (Xa/Xb) of the PTFE content Xa in the channel facing parts 24A with respect to the PTFE content Xb in the rib facing parts 24B in the air inlet side region and (b) the cell voltage (mV).

Considerations:

As can be seen from FIG. 4, cells 2 to 5 can produce a higher cell voltage than cells 6 and 7. Therefore, it is preferable to set the ratio (Xa/Xb) in a range of 0.2 to 0.8.

The reason for this can be considered as follows. For cells 2 to 5, the ratio (Xa/Xb) in the cathode side diffusion layer is set in a range of 0.2 to 0.8. This means that the water retentivity of the channel facing parts 24A is appropriately higher than that of the rib facing parts 24B. Therefore, the wettability of the proton exchange membrane and the electrode layer is made uniform in the channel facing parts 24A and the rib facing parts 24B. For cells 6 and 7, however, the effect of such uniform wettability is not provided.

Also, cell 1 produces a considerably low cell voltage, compared with cells 2 to 5.

The reason for this can be considered as follows. For cell 1, the fluorocarbon resin content in the channel facing parts 24 in the air inlet side region is considerably low. This allows water to reside in these parts, extremely degrading the gas diffusibility.

Also, another experiment was carried out to examine an appropriate range of the water retentivity adjustment. Known clearly from this experiment is that the water retentivity of less than 10 wt % in a region from the air inlet side end toward the outlet side of the cathode side gas diffusion layer fails to achieve sufficient water repellency, whereas the water retentivity of more than 90 wt % in that region extremely degrades the gas diffusibility.

From the above experiment, it is considered preferable to set the fluorocarbon resin content in the air inlet side region of the cathode side gas diffusion layer, in a range of 10 to 90 wt %.

[Second Embodiment]

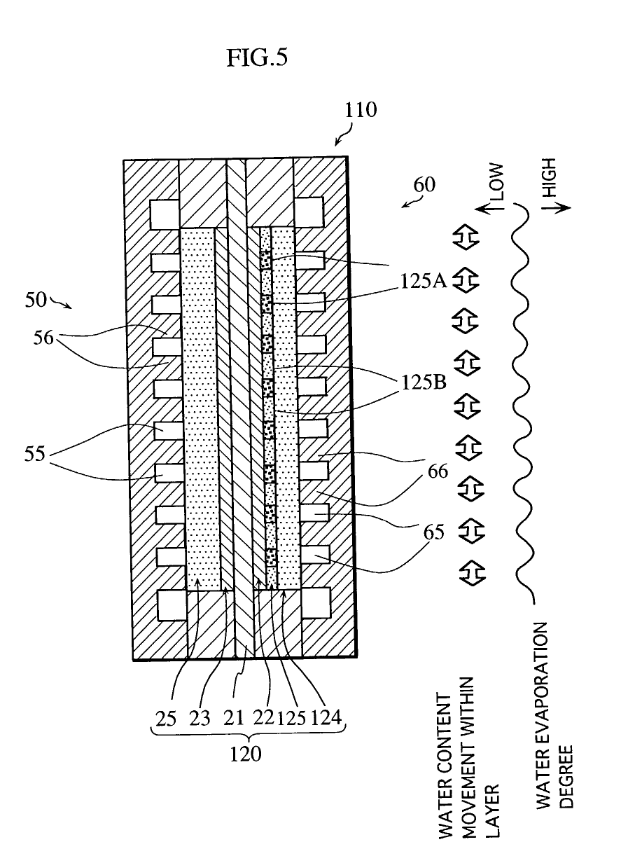

FIG. 5 is a schematic cross section of a cell unit relating to the present embodiment in the air inlet side region, taken in the thickness direction thereof.

A cell unit 110 in the present embodiment has the same construction as the cell unit 10 shown in FIG. 1 in the first embodiment except that a cathode side gas diffusion layer 124 in a membrane/electrode assembly 120 has a different construction from the cathode side gas diffusion layer 24 in the first embodiment.

In the present embodiment, the cathode side gas diffusion layer 124, as the above gas diffusion layer 24, is made of a conductive porous material such as carbon paper to which a water repellent material is added to ensure gas diffusibility. Besides this, a mixture of carbon particles and a water repellent material is applied on the surface of the cathode side gas diffusion layer 124 facing the cathode catalyst layer 22, so as to form a water retentivity adjustment layer 125.

The water retentivity adjustment layer 125 is superior in water retentivity as it contains carbon particles. The water retentivity adjustment layer 125 present adjacent to the cathode catalyst layer 22 enables the proton exchange membrane 21 and the cathode catalyst layer 22 to be maintained humid with stability.

In the present embodiment, the water retentivity adjustment is performed in the air inlet side region 20A of the water retentivity adjustment layer 125. To be more specific, in the air inlet side region 20A of the water retentivity adjustment layer 125, water retentivity of parts facing the oxidant channels 65 (channel facing parts 125A) is adjusted to be higher than water retentivity of parts facing the ribs 66 (rib facing parts 125B).

Such water retentivity adjustment in the water retentivity adjustment layer 125 is specifically accomplished, by using carbon particles with a large specific surface for the channel facing parts 125A and carbon particles with a small specific surface for the rib facing parts 125B.

In general, carbon particles with a larger specific surface has higher water retentivity (an amount of water that carbon particles of a predetermined weight can contain). Therefore, by determining a specific surface of a carbon material for use in the water retentivity adjustment layer 125 in the above described way, the water retentivity of the channel facing parts 125A can be made higher than that of the rib facing parts 125B.

By providing the cathode side gas diffusion layer 124 with the water retentivity adjustment layer 125 whose water retentivity has been adjusted as described above, the same effect as described in the first embodiment can be produced. That is, wettability of the proton exchange membrane and the catalyst layer can be made uniform in the parts facing the oxidant channels 65 and the parts facing the ribs 66.

Also, a change in a specific surface of a carbon material for use in the water retentivity adjustment layer 125 does not have much effect on its gas permeability, and therefore, the gas permeability can be maintained uniform in the entire reaction region of the water retentivity adjustment layer 125.

### PRACTICAL EXAMPLE 2

Based upon the above second embodiment, cells 8 to 10 of practical examples, and cells 11 and 12 of comparative examples were produced according to the same specification as employed in the practical experiment 1, except the cathode side gas diffusion layer. The cell voltage measuring experiment was carried out on each cell.

TABLE 2

| | Specific Surface of Carbon (m²/g) | | Carbon Specific |
|---|---|---|---|
| | Channel Facing Part | Rib Facing Part | Surface Ratio |
| | Ya | Yb | Ya/Yb |
| Cell 8 | 1270 | 254 | 5.00 |
| Cell 9 | 800 | 254 | 3.15 |
| Cell 10 | 343 | 254 | 1.35 |
| Cell 11 | 254 | 254 | 1.00 |
| Cell 12 | 56 | 254 | 0.22 |

For cells 8 to 10, the cathode side gas diffusion layer was formed in the following way. Carbon paper was filled with PTFE as a water repellent material (the PTFE content uniformly set at 30 wt %), so as to have a size of 10*10 cm and a thickness of 200 μm. On the surface of this layer, a mixture of carbon particles and PTFE was applied, to form the water retentivity adjustment layer. In the air inlet side region of the water retentivity adjustment layer (50% of the entire region), water retentivity of the channel facing parts 125A was adjusted to be higher than that of the rib facing parts 125B, by using carbon particles with a larger specific surface for the channel facing parts 125A as shown in Table 2.

For each cell, the PTFE content in the mixture forming the water retentivity adjustment layer was set uniformly at 30 wt %.

As Table 2 shows, for cell 11 of comparative example, carbon particles with the same specific surface were used for the channel facing parts 125A and the rib facing parts 125B in the water retentivity adjustment layer. For cell 12 of comparative example, carbon particles with a smaller specific surface than that for the rib facing parts 125B were used for the channel facing parts 125A in the water retentivity adjustment layer 125, to decrease the water retentivity thereof. Except for these points, cells 11 and 12 of comparative examples were produced in the same manner as the above cells 8 to 10.

The following describes a method for producing each cell in detail.

Cathode side gas diffusion layer: carbon paper (thickness: 200 μm) was prepared, immersed in a PTFE dispersion solution, and baked for one hour at 380° C. The PTFE content at this point was set uniformly in the entire region at 30 wt %.

Carbon particles with a specific surface of 254 m²/g and a PTFE dispersion solution were mixed to form a mixture slurry (the PTFE content within the solid content: 30 wt %). Then, a masking sheet was placed only on parts corresponding to the channel facing parts 124A in the air inlet side region. The mixture dispersion solution was applied thereon.

Following this, five types of carbon particles respectively having specific surface values of 1270, 800, 343, 254, and 56 m²/g each were mixed with the PTFE dispersion solution to form five mixture slurries (the PTFE content within the solid content: 30 wt %). A masking sheet having apertures corresponding to the channel facing parts 125A in the air inlet side region was placed on the layer. The corresponding one of the five mixture slurries was applied thereon. Then, the layer was baked for one hour at 380° C.

As described above, the cathode side gas diffusion layers for cells 8 to 12 were completed. Using these cathode side gas diffusion layers, cells 8 to 12 were produced as in the above practical example 1.

(Cell Voltage Measuring Experiment)

The cells of practical examples and comparative examples produced as described above were operated under the same conditions as employed in the cell voltage measuring experiment in the practical example 1, and the cell voltage was measured.

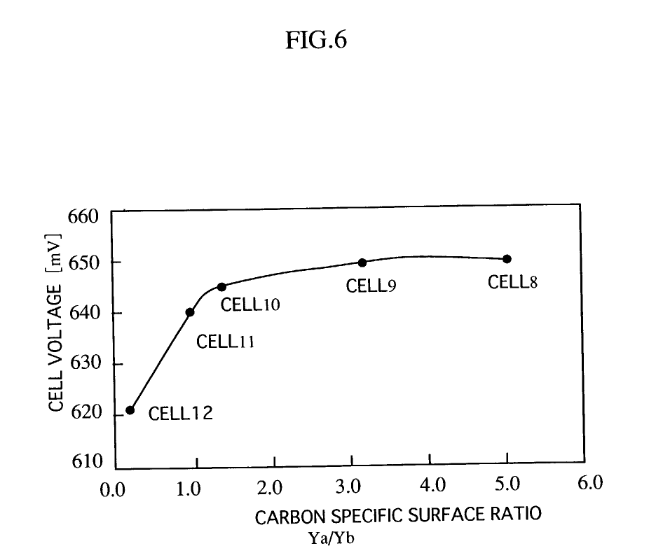

FIG. 6 shows the cell voltage measurement value of each cell, and is a characteristic diagram showing the relationship between (a) the ratio (Ya/Yb) of a specific surface Yb of a carbon particle for use in the rib facing parts 125A with respect to a specific surface Ya of a carbon particle for use in the channel facing parts 125B, in the air inlet side region and (b) the cell voltage (mV).

Considerations:

As can be seen from FIG. 6, cells 8 to 10 can produce a higher cell voltage than cells 11 and 12.

The reason for this can be considered as follows. For cells 8 to 10, the ratio (Ya/Yb) of the specific surface in the air inlet side region of the water retentivity adjustment layer 125 was set in a range of 1.35 to 5. Therefore, water retentivity of the channel facing parts 125A is appropriately higher than that of the rib facing parts 125B. Due to this, for cells 8 to 10, wettability of the proton exchange membrane and the electrode layer is made uniform in the channel facing parts 125A and the rib facing parts 125B, whereas for cells 11 and 12, the effect of such uniform wettability is not provided.

[Third Embodiment]

A cell unit relating to the present embodiment has the same construction as the cell unit 110 in the second embodiment, with the only difference being in a method for adjusting water retentivity in the water retentivity adjustment layer 125.

To be more specific, in the second embodiment, the water retentivity of the channel facing parts 124A and the rib facing parts 125B in the water retentivity adjustment layer 125 is adjusted by using carbon particles with different specific surfaces. In the present embodiment, however, it is adjusted by setting an added amount of a water repellent material to the water repellent material smaller in the channel facing parts 125A than in the rib facing parts 125B.

This can also decrease the tendency that parts of the proton exchange membrane and the cathode catalyst layer that face the oxidant channels 65 are more liable to dry as described in the first embodiment. Therefore, the wettability can be made uniform in the parts facing the oxidant channels 65 and the parts facing the ribs 66 in the membrane/electrode assembly 120.

### PRACTICAL EXAMPLE 3

Based upon the above third embodiment, cells 13 to 17 of practical examples, and cells 18 and 19 of comparative examples were produced according to the same specification as employed in the practical example 1 except the cathode side gas diffusion layer 124. The cell voltage measuring experiment was carried out on each cell.

TABLE 3

| | PTFE Content in Water Retentivity | | |
|---|---|---|---|
| | Adjustment Layer | | |
| | Channel Facing Part | Rib Facing Part | PTFE Content Ratio |
| | Za | Zb | Za/Zb |
| Cell 13 | 4 | 30 | 0.13 |
| Cell 14 | 6 | 30 | 0.20 |
| Cell 15 | 10 | 30 | 0.33 |
| Cell 16 | 17 | 30 | 0.57 |
| Cell 17 | 25 | 30 | 0.83 |
| Cell 18 | 30 | 30 | 1.00 |
| Cell 19 | 40 | 30 | 1.33 |

For cells 13 to 17, the cathode side gas diffusion layer was formed in the following way. Carbon paper was filled with PTFE as a water repellent material (the PTFE content uniformly set at 30 wt %), so as to have a size of 10*10 cm and a thickness of 200 μm. A mixture of carbon particles and a PTFE resin was then applied on the surface of this layer, to form the water retentivity adjustment layer. In the air inlet side region of the water retentivity adjustment layer (50% of the entire region), the PTFE resin content was set smaller in the channel facing parts 125A than in the rib facing parts 125B as shown in Table 3, so as to increase the water retentivity thereof.

As Table 3 shows, for cell 18 of comparative example, the PTFE content was set at the same value in the channel facing parts 125A and the rib facing parts 125B in the water retentivity adjustment layer 125. For cell 19 of comparative example, the PTFE content was set higher in the channel facing parts 125A than in the rib facing parts 125B in the water retentivity adjustment layer 125, to decrease the water retentivity thereof. Except for these points, cells 18 and 19 of comparative examples were produced in the same manner as the above cells 13 to 17.

The following describes a method for producing each cell in detail.

Cathode side gas diffusion layer: carbon paper (thickness: 200 μm) was prepared, immersed in a PTFE dispersion solution, and baked for one hour at 380° C. The PTFE content at this point was set uniformly in the entire region at 30 wt %.

Carbon particles with a specific surface of 254 m²/g and a PTFE dispersion solution were mixed to form a mixture slurry (the PTFE content within the solid content: 30 wt %). Then, a masking sheet was placed only on parts corresponding to the channel facing parts 124A in the air inlet side region. The mixture dispersion solution was applied thereon.

Following this, carbon particles with a specific surface of 254 m²/g and the PTFE dispersion solution were mixed to form mixture slurries whose PTFE content within the solid content is respectively set at 4, 6, 10, 17, 25, 30, and 40 wt %. Then, a masking sheet having apertures corresponding to the channel facing parts 125A in the air inlet side region was placed on the layer. The corresponding one of the mixture slurries was applied thereon, and the layer was baked for one hour at 380° C.

As described above, the cathode side gas diffusion layers for cells 13 to 19 were completed. Using these cathode side gas diffusion layers, cells 8 to 12 were produced in the same manner as in the practical example 1.

(Cell Voltage Measuring Experiment)

The cells of practical examples and comparative examples produced as described above were operated under the same conditions as employed in the cell voltage measuring experiment in the practical example 1, and the cell voltage was measured.

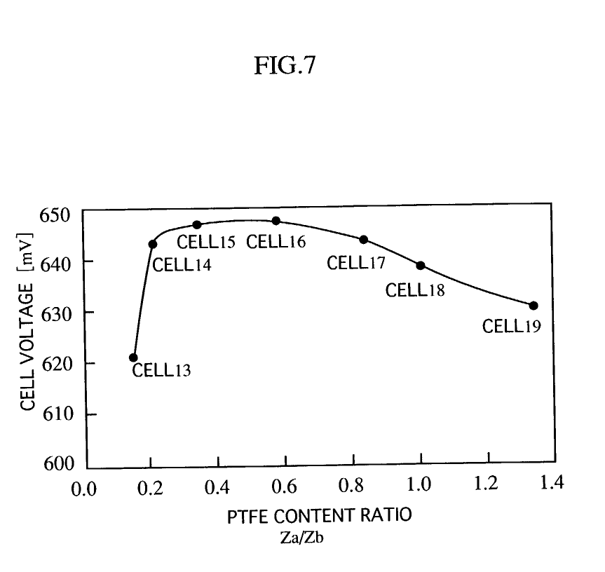

FIG. 7 shows the cell voltage measurement value of each cell, and is a characteristic diagram showing the relationship between (a) the ratio (Za/Zb) of the PTFE content (Zb) in the rib facing parts 125 with respect to the PTFE content (Za) in the channel facing parts 125B in the air inlet side region of the water retentivity adjustment layer 125 and (b) the cell voltage (mV).

Considerations:

As can be seen from FIG. 7, cells 14 to 17 can produce a higher cell voltage than cells 18 and 19. From this, it is considered preferable to set, within the water retentivity adjustment layer 125, the ratio of the fluorocarbon resin content in the channel facing parts 125A with respect to that in the rib facing parts 125B, in a range of 0.2 to 0.8.

The reason for this can be considered as follows. For cells 14 to 17, in the air inlet side region of the water retentivity adjustment layer 125, the ratio of the fluorocarbon resin content in the channel facing parts 125A with respect to that in the rib facing parts 125B was set in a range of 0.2 to 0.8. Due to this, the water retentivity of the channel facing parts 125A is appropriately higher than that of the rib facing parts 125B. For cells 14 to 17, therefore, wettability of the proton exchange membrane and the electrode layer is made uniform in the channel facing parts 125A and the rib facing parts 125B, whereas for cells 18 and 19, the effect of such uniform wettability is not provided.

Also, as compared with cells 14 to 17, cell 13 produces a considerably low cell voltage. The reason for this can be considered as follows. For cell 13, the PTFE resin content in the water retentivity adjustment layer in the channel facing parts 125A in the air inlet side region is considerably low. This allows water to reside in these parts, extremely degrading the gas diffusibility.

[Fourth Embodiment]

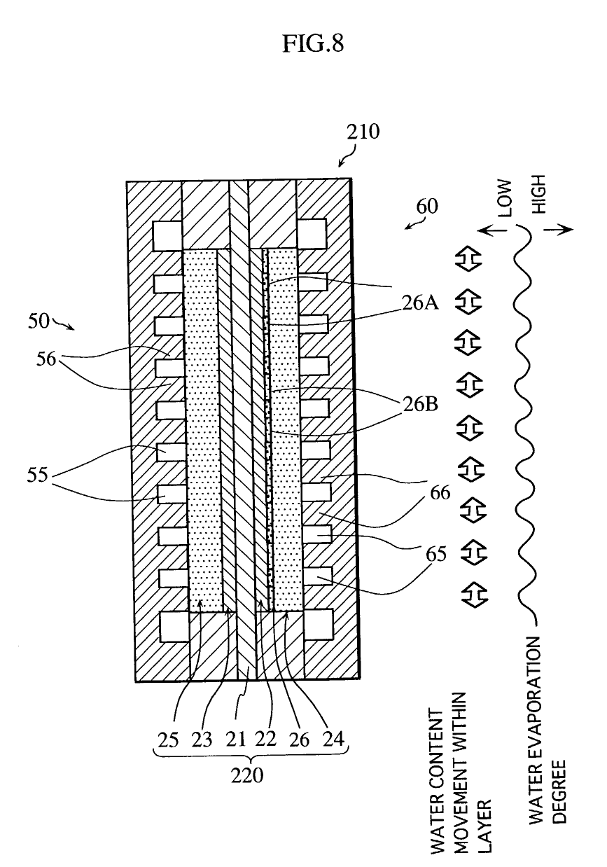

FIG. 8 is a schematic cross section of a cell unit relating to the present embodiment in the air inlet side region, taken in the thickness direction thereof.

A cell unit 210 in the present embodiment has the same construction as the cell unit 10 shown in FIG. 1 in the first embodiment, except that an intermediate water retentive layer 26 made of an ion exchanger is provided between a cathode side gas diffusion layer 24 and a cathode catalyst layer 22 in a membrane/electrode assembly 220. In the present embodiment, water retentivity adjustment is performed in channel facing parts and rib facing parts of this intermediate water retentive layer 26.

In the present embodiment, the cathode side gas diffusion layer 24 is made of a conductive porous material such as carbon paper to which a water repellent material is uniformly added to ensure the gas diffusibility.

Further, an ion exchanger resin is applied on the surface of the cathode catalyst layer 22 on the cathode side gas diffusion layer 24, to form the intermediate water retentive layer 26 therebetween.

The intermediate water retentive layer 26 is superior in water retentivity as it is made of the ion exchanger resin. The intermediate water retentive layer 26 present adjacent to the cathode catalyst layer 22 enables the proton exchange membrane 21 and the cathode catalyst layer 22 to be maintained humid with stability.

Also, the water retentivity of the intermediate water retentive layer 26 is adjusted to be higher in its parts facing the oxidant channel 65 (channel facing parts 26A) than in its parts facing the ribs 66 (rib facing parts 26B).

Such water retentivity adjustment in the intermediate water retentive layer 26 is specifically accomplished, by increasing an applied amount of the ion exchanger resin in the channel facing parts 26A and decreasing an applied amount of the ion exchanger resin in the rib facing parts 26B (or not applying the ion exchanger resin in the rib facing parts 26B).

Alternatively, the water retentivity adjustment can be accomplished by using an ion exchanger resin with a larger ion-exchange capacity in the channel facing parts 26A and using an ion exchanger resin with a smaller ion-exchange capacity in the rib facing parts 26B.

By providing the intermediate water retentive layer 26 whose water retentivity is adjusted in the above described way between the cathode catalyst layer 22 and the cathode side gas diffusion layer 24, the same effects as described in the first embodiment can be produced. To be more specific, the wettability of the proton exchange membrane 21 and the cathode catalyst layer 22 can be made uniform in the parts facing the oxidant channels 65 and the parts facing the ribs 66.

Also, it is preferable to set the size of the air inlet side region 20A where the intermediate water retentive layer 26 is to be provided, in a range of 10 to 90% inclusive of the size of the entire gas diffusion layer 24 for the same reason described in the first embodiment.

### PRACTICAL EXAMPLE 4

Based upon the above second embodiment, cells 20 and 21 of practical examples were produced according to the same specification as employed in the practical example 1, except that an ion exchanger resin is applied on the surface of the cathode side gas diffusion layer to form an intermediate water retentive layer. The cell voltage measuring experiment was carried out on each cell.

For cell 20 and 21, the cathode side gas diffusion layer was formed by filling carbon paper with PTFE as a water repellent material, and baking it for one hour at 380° C. (the PTFE content set uniformly at 30 wt %), so as to have a size of 10*10 cm and a thickness of 200 μm.

For cell 20, in the air inlet side region (50% of the entire region) on the surface of the cathode side gas diffusion layer, a masking sheet having apertures corresponding to the channel facing parts 126A was placed. An ion exchanger resin with an ion-exchange capacity of 1.0 meq./g (an alcohol solution) was applied thereon, and then was dried for 20 min. at 80° C. to remove alcohol. At this point, the applied amount of the ion exchanger resin in the channel facing parts 26A was set at 0.06 mg/cm².

In this way, the ion exchanger resin was applied only on the channel facing parts 26A of the intermediate water retentive layer 26 formed on the cathode side gas diffusion layer and not on the rib facing parts 26B of the intermediate water retentive layer 26. Accordingly, in the intermediate water retentive layer 26, water retentivity of the channel facing parts 26A is higher than that of the rib facing parts 26B.

For cell 21, in the air inlet side region on the surface of the cathode side gas diffusion layer (50% of the entire region), an ion exchanger resin with an ion-exchange capacity of 1.0 meq./g was applied, by an amount of 0.06 mg/cm², on the parts corresponding to the channel facing parts 26A in the same manner as that for cell 20. Then, in the air inlet side region on the surface of the cathode side gas diffusion layer (50% of the entire region), a masking sheet having apertures corresponding to the rib facing parts 26B was placed, an ion exchanger resin (an alcohol solution) with an ion-exchange capacity of 0.91 meq./g was applied thereon, and was dried for 20 min. at 80° C. to remove alcohol. The applied amount of the ion exchanger resin in the rib facing parts 26B was also set at 0.06 mg/cm².

In this way, the ion exchanger resin with a relatively high ion-exchange capacity was applied only on the channel facing parts 26A of the intermediate water retentive layer 26 formed on the cathode side gas diffusion layer, and the ion exchanger resin with a relatively low ion-exchange capacity was applied on the rib facing parts 26B of the intermediate water retentive layer 26. Accordingly, in the intermediate water retentive layer 26, water retentivity of the channel facing parts 26A can be made higher than that of the rib facing parts 26B.

### COMPARATIVE EXAMPLE

Also, as comparative examples, cells 22 to 29 were produced in the same manner as that for the above cells 20 and 21, except that an ion exchanger resin with an ion-exchange capacity of 1.0 meq./g was uniformly applied in the air inlet side region (50% of the entire region) on the surface of the cathode side gas diffusion layer, to form an intermediate water retentive layer.

Here, for cells 22 to 29, the applied amount of the ion exchanger resin was set at values shown in Table 4.

TABLE 4

Ion Exchanger Resin Applied
Amount Ion-Exchange Capacity

| | Channel Facing Part | Rib Facing Part |
|---|---|---|
| Cell 20 | 0.06 mg/cm² | 0 |
| | 1.0 meq./g | |
| Cell 21 | 0.06 mg/cm² | 0.06 mg/cm² |
| | 1.0 meq./g | 0.91 meq./g |

| | |
|---|---|
| Cell 22 | 0.01 mg/cm² 1.0 meq./g |
| Cell 23 | 0.02 mg/cm² 1.0 meq./g |
| Cell 24 | 0.04 mg/cm² 1.0 meq./g |
| Cell 25 | 0.06 mg/cm² 1.0 meq./g |
| Cell 26 | 0.08 mg/cm² 1.0 meq./g |
| Cell 27 | 0.1 mg/cm² 1.0 meq./g |
| Cell 28 | 0.12 mg/cm² 1.0 meq./g |
| Cell 29 | 0.15 mg/cm² 1.0 meq./g |
| Cell 30 | 0 |

Note that cell 30 was produced in the same manner as that for cells 20 and 21 except that an ion exchanger resin was not applied (an intermediate water retentive layer was not formed).

(Cell Voltage Measuring Experiment)

The cells of practical examples and comparative examples produced as described above were operated under the following conditions, and the cell voltage was measured.

Current Density: 0.5A/cm²

Operating Temperature within Cell: 80° C.

Fuel Gas: pure hydrogen

Oxidizing Gas: air

Fuel Gas Utilization Ratio: 70%

Oxidizing Gas Utilization Ratio: 40%

Gas Humidifying Temperature: fuel gas being humidified at 80° C., and oxidizing gas not being humidified

The experimental results showed that the cell voltage measurement value was 632 mV for cell 20 of practical example, and 643 mV for cell 21 of practical example.

For cell 25 of comparative example, the cell voltage measurement value was 634 mV.

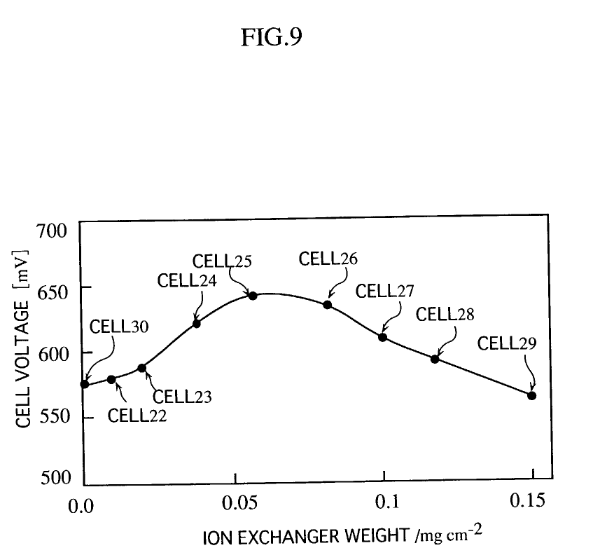

FIG. 9 shows the cell voltage measurement value of each cell.

Considerations:

As can be seen from FIG. 9, cells 23 to 28 with the applied amount of the ion exchanger resin being in a range of 0.02 to 0.12 mg/cm² can produce a higher cell voltage than cells 23 and 30 with the applied amount of the ion exchanger resin being 0.01 mg/cm² or less and cell 29 with the applied amount of the ion exchanger resin being 0.15 mg/cm².

These experimental results indicate the following. When the cell is operated with an oxidizing gas not being humidified, a large amount of water content is lost due to evaporation from the membrane/electrode assembly if the intermediate water retentive layer is not provided. On the other hand, an intermediate water retentive layer with appropriate water retentivity, if provided, can prevent the water evaporation from the membrane/electrode assembly, thereby enabling a higher cell voltage to be obtained.

The experimental results also indicate that it is difficult to obtain a high cell voltage when an excessively large amount of ion exchanger resin is applied to form the intermediate water retentive layer. This can be considered due to the following reason. Because the ion exchanger resin itself is non-conductive, too much ion exchanger resin being applied causes the electrical resistance between the cathode catalyst layer and the gas diffusion layer to increase to a great degree.

Next, comparing cell 20 of practical example with cell 25 of comparative example, the total applied amount of ion exchanger resin of cell 20 is about half of that of cell 25. However, cells 20 and 25 each produce a similar cell voltage. Also, comparing cell 20 of practical example with cell 23 or with cell 24 of comparative example, cell 20 of practical example produces a higher cell voltage than cells 23 or 24 although the total applied amount of ion exchanger resin of these cells is the same.

The reason for this can be considered as follows. For cell 24 of practical example, in the air inlet side region, the water retentivity of the channel facing parts is appropriately higher than that of the rib facing parts in the intermediate water retentive layer. Therefore, the wettability of the proton exchange membrane and the electrode layer is made uniform in the channel facing parts and the rib facing parts, whereas for the cells of comparative examples, the effect of such uniform wettability is not provided.

[Fifth Embodiment]

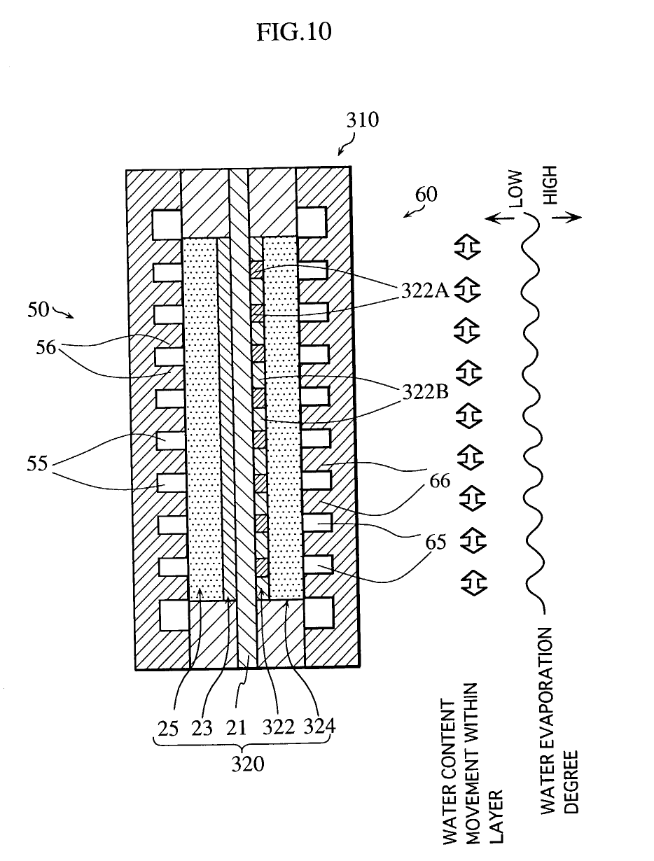

FIG. 10 is a schematic cross section of a cell unit relating to the present embodiment in the air inlet side region, taken in the thickness direction thereof.

A cell unit 310 in the present embodiment has the same construction as the cell unit 10 shown in FIG. 1 in the first embodiment, except that the water retentivity is not adjusted in a cathode side gas diffusion layer 324 but is adjusted in a cathode catalyst layer 322 in a membrane/electrode assembly 220.

In the present embodiment, the cathode catalyst layer 322 is made of platinum catalyst support carbon as the above cathode catalyst layer 22. However, the water retentivity of channel facing parts 322A facing the oxidant channels 65 is set higher than that of rib facing parts 332B facing the ribs 66 in the present embodiment.

This water retentivity adjustment in the cathode catalyst layer 322 is specifically accomplished, by using carbon particles with a larger specific surface (carbon particles with a high water retentivity) as a catalyst support in the channel facing parts 322A and using carbon particles with a smaller specific surface (carbon particles with a low water retentivity) in the rib facing parts 222B.

By providing such a cathode catalyst layer 322 whose water retentivity has been adjusted, the same effects as described in the first embodiment can be produced.

To be more specific, the wettability of the proton exchange membrane and the catalyst layer can be made uniform in the parts facing the oxidant channels 65 and the parts facing the ribs 66.

### PRACTICAL EXAMPLE 5

Based upon the above fifth embodiment, a cell relating to the practical example 5 was produced according to the same specification as employed in the practical example 1 except the cathode catalyst layer 322 and the cathode side gas diffusion layer 324.

In the present example, the cathode side gas diffusion layer 324 was made by filling carbon paper with PTFE as a water repellent material (PTFE content set uniformly at 30 wt %), so as to have a size of 10*10 cm and a thickness of 200 μm.

The cathode catalyst layer 322 uniformly includes Pt support carbon particles, Nafion, and PTFE at a weight ratio of 100:20:10 in the entire region. Carbon particles used as a catalyst support in the channel facing parts 322A have a specific surface of 800 m²/g, whereas carbon particles used as a catalyst support in the rib facing parts 322B have a specific surface of 254 m²/g.

The following describes a method for producing a cell in detail.

Carbon particles with a specific surface of 254 m²/g were made to support platinum, to form Pt support carbon particles. This Pt support carbon particles, a Nafion solution, and PTFE were mixed at a weight ratio of Pt support carbon particles:Nafion:PTFE as 100:20:10, to form a mixture slurry A.

Also, carbon particles with a specific surface of 800 m²/g were made to support platinum, to form Pt support carbon particles. This Pt support carbon particles, a Nafion solution, and PTFE were mixed at a weight ratio of Pt support carbon particles:Nafion:PTFE as 100:20:10, to form a mixture slurry B.

A masking sheet having apertures corresponding to the channel facing parts 322A in the air inlet side region was placed on the carbon paper filled with a water repellent material (a cathode side gas diffusion layer), on which the mixture slurry B was applied.

Following this, a masking sheet having apertures corresponding to the rib facing parts 322B in the air inlet side region was placed on the layer, on which the mixture slurry A was applied, to form the cathode catalyst layer 322.

Using this cathode side gas diffusion layer on which the cathode catalyst layer is formed, the cell was produced in the same manner as in the practical example 1.

The cell voltage measuring experiment was carried out on the cell of practical example produced in this way and a cell of comparative example in which specific surfaces of carbons for use in the channel facing parts 322A and the rib facing parts 322B in the cathode catalyst layer were not adjusted. The experimental results indicate that the cell of practical example produces a higher cell voltage than the cell of comparative example.

[Sixth Embodiment]

A cell unit in the present embodiment has the same construction as the cell unit 310 in the fifth embodiment with the only difference being in a method for adjusting water retentivity of the cathode catalyst layer 322.

Specifically, in the above fifth embodiment, the water retentivity of the channel facing parts 322A and the rib facing parts 322B in the cathode catalyst layer 322 is adjusted by using carbon materials with different specific surfaces for the channel facing parts 322A and the rib facing parts 322B. In the present embodiment, however, such adjustment can be accomplished by setting an amount of ion exchanger to be added larger in the cathode catalyst layer 322 than in the rib facing parts 322B.

This can also decrease the tendency that the parts of the proton exchange membrane and the cathode catalyst layer that face the oxidant channels 65 are more liable to dry. Accordingly, the wettability of the membrane/electrode assembly 320 can be made uniform in the parts facing the oxidant channels 65 and the parts facing the ribs 66.

### PRACTICAL EXAMPLE 6

Based upon the above sixth embodiment, a cell was produced according to the same specification as employed in the practical example 5 except the cathode catalyst layer 322.

The cathode catalyst layer 322 in the present example uniformly includes carbon particles with a specific surface of 254 m²/gas a catalyst support in the entire region. However, the weight ratio of Pt support carbon particles, Nafion, and PTFE is 100:40:10 in the channel facing parts 322A, whereas it is 100:20:10 in the rib facing parts 322B.

The following describes a method for producing the cell in detail.

The mixture slurry A that is the same as described in the practical example 5 was prepared.

Carbon particles with a specific surface of 254 m²/g were made to support platinum, to form Pt support carbon particles. This Pt support carbon particles, a Nafion solution, and PTFE were mixed at a weight ratio of Pt support carbon particles:Nafion:PTFE as 100:40:10, to form a mixture slurry C.

A masking sheet having apertures corresponding to the channel facing parts 322A in the air inlet side region was placed on the carbon paper filled with a water repellent material (a cathode side gas diffusion layer). Then, the mixture slurry C was applied on the layer.

Following this, a masking sheet having apertures corresponding to the rib facing parts 322B in the air inlet side region was placed on the layer, on which the mixture slurry A was applied, to form the cathode catalyst layer 322.

Using this cathode side gas diffusion layer on which the cathode catalyst layer is formed, the cell was produced in the same manner as in the practical example 1.

The cell voltage measuring experiment was carried out in the same manner as in the practical example 1, on the cell of practical example produced in this way and a cell of comparative example in which the amount of Nafion in the channel facing parts 322A and in the rib facing parts 322B in the cathode catalyst layer was not adjusted. The experimental results indicate that the cell of practical example produces a higher cell voltage than the cell of comparative example.

[Modifications]

The above second and third embodiments describe the case where the water retentivity adjustment layer 125 is provided only on the surface of the cathode side gas diffusion layer 124 facing the cathode catalyst layer 22. However, the position where the water retentivity adjustment layer 125 is provided is not limited to such. The water retentivity adjustment layer 125 may be provided at the gas channel side, or may be provided on the entire part of the gas diffusion layer in the thickness direction.

In the second to sixth embodiments, too, as in the first embodiment, it is preferable to perform the above described water retentivity adjustment between the channel facing parts and the rib facing parts of the cathode side gas diffusion layer, the cathode catalyst layer, or the intermediate water retentive layer, on a predetermined range from the oxidant inlet side end toward the outlet side (more preferably in a region of 10 to 90% of the entire region from the oxidant inlet side end to the outlet side end in the cathode side diffusion layer or in the cathode catalyst layer), so as to obtain the effect of making the wettability uniform.

The above embodiments each describe the case where the water retentivity adjustment is performed in a region of a predetermined range from the oxidant gas inlet side end within the cathode side gas diffusion layer or within the cathode catalyst layer. To produce the same effect, a range where the water retentivity adjustment is to be performed may be distant from the oxidant gas inlet side end as long as it is close to the oxidant gas inlet side.

Two or more of the water retentivity adjustment methods for the cathode side gas diffusion layer or the cathode catalyst layer described in the first to sixth embodiments may be combined for use.

The second embodiment describes the case where the water retentivity adjustment layer made of a mixture of carbon particles and a water repellent material is formed only on the cathode side gas diffusion layer. However, another water retentive adjustment layer made of a mixture of carbon particles and a water repellent material may be formed on the anode side gas diffusion layer. By doing so, a greater effect of humidifying the proton exchange membrane can be expected.

The above embodiments are described based on a cell unit in which an oxidizing gas and a fuel gas flow in parallel. However, the construction of the cell unit shouldnotbe limited to such. For example, the cell unit may have the construction in which channels of the cathode side separator plate and those of the anode side separator plate are perpendicular with each other.

Besides the water retentivity adjustment between the channel facing parts and the rib facing parts described above, the water repellent material content may also be adjusted in such a manner that the water repellency in the gas diffusion layer is higher in the air inlet side region 20A than in the air outlet region 20B.

By combining these adjustments between the air inlet side region and the air outlet side region, water evaporation is suppressed in the air inlet side region 20A, as compared in the air outlet side region 20B. Therefore, the wettability of the proton exchange membrane and the catalyst layer can be made uniform in the air inlet side and the air outlet side.

The above embodiments are described taking a typical proton exchange membrane fuel cell that generates electricity using a fuel gas as example. However, the present invention is applicable to a direct methanol fuel cell (DMFC) that generates electricity while supplying methanol instead of a fuel gas directly to the anode side.

### INDUSTRIAL APPLICATION

The present invention can be utilized in generators, generation systems, cogeneration systems, electric cars, and the like that use a fuel cell that includes a cell unit formed by arranging an anode and a cathode on a proton exchange membrane.

1. A fuel cell comprising:
a cell unit that is formed by arranging a cathode catalyst layer on one surface of a proton exchange membrane and an anode catalyst layer on another surface of the proton exchange membrane;
a first plate on which fuel channels for supplying a fuel are formed; and
a second plate on which (a) oxidant channels for supplying an oxidant and (b) ribs are formed, the second plate and the first plate sandwiching the cell unit in such a manner that the oxidant channels and the ribs face the cathode catalyst layer and the fuel channels face the anode catalyst layer,
wherein a gas diffusion layer is interposed between the cathode catalyst layer and the second plate, and
at least one of the gas diffusion layer and the cathode catalyst layer is constructed in such a manner that water retentivity is higher in parts facing the oxidant channels than in parts facing the ribs.

2. The fuel cell of claim 1,
wherein the at least one of the gas diffusion layer and the cathode catalyst layer is constructed in such a manner that, in a vicinity of an inlet for the oxidant, water retentivity is higher in the parts facing the oxidant channels than in the parts facing the ribs.

3. The fuel cell of claim 1,
wherein the at least one of the gas diffusion layer and the cathode catalyst layer is constructed in such a manner that, in a predetermined region extending from an oxidant inlet side end of the at least one of the gas diffusion layer and the cathode catalyst layer toward an oxidant outlet side thereof, water retentivity is higher in the parts facing the oxidant channels than in the parts facing the ribs.

4. The fuel cell of claim 3,
wherein a size of the predetermined region is in a range of 10% to 90% inclusive of a size of an entire region extending from the oxidant inlet side end of the gas diffusion layer to an oxidant outlet side end thereof.

5. The fuel cell of any of claims 1 to 4,
wherein the gas diffusion layer is made of a conductive base material that contains a water repellent material, and an amount of the water repellent material in the gas diffusion layer is smaller in the parts facing the oxidant channels than in the parts facing the ribs.

6. The fuel cell of claim 5,
wherein the gas diffusion layer is constructed in such a manner that a ratio of (a) the amount of the water repellent material in the parts facing the oxidant channels with respect to (b) the amount of the water repellent material in the parts facing the ribs is in a range of 0.2 to 0.8 inclusive.

7. The fuel cell of any of claims 1 to 4,
wherein the gas diffusion layer has a water retentivity adjustment layer that is formed by applying a mixture containing carbon particles, and
the water retentivity adjustment layer is constructed in such a manner that water retentivity is higher in parts facing the oxidant channels than in parts facing the ribs.

8. The fuel cell of claim 7,
wherein in the gas diffusion layer, carbon particles that are used in the parts facing the oxidant channels have higher water retentivity than carbon particles that are used in the parts facing the ribs.

9. The fuel cell of claim 7,
wherein in the gas diffusion layer, carbon particles that are used in the parts facing the oxidant channels have a larger specific surface area than carbon particles that are used in the parts facing the ribs.

10. The fuel cell of claim 7,
wherein the water retentivity adjustment layer is formed by applying a mixture of carbon particles and a water repellent material, and
a ratio of (a) an amount of the water repellent material in a mixture applied in the parts facing the oxidant channels with respect to (b) an amount of the water repellent material in a mixture applied in the parts facing ribs is in a range of 0.2 to 0.8 inclusive.

11. The fuel cell of claim 1,
wherein the cathode catalyst layer is made of a mixture of (a) carbon particles that support a catalyst and (b) an ion exchanger, and
carbon particles that are used in the parts facing the ribs have a larger specific surface area than carbon particles that are used in the parts at an oxidant outlet side.

12. The fuel cell of claim 1,
wherein the cathode catalyst layer is made of a mixture of (a) carbon particles that support a catalyst and (b) an ion exchanger, and
an amount of the ion exchanger in the cathode catalyst layer is larger in the parts facing the oxidant channels than in the parts facing the ribs.

13. A fuel cell comprising:
a cell unit that is formed by arranging a cathode catalyst layer on one surface of a proton exchange membrane and an anode catalyst layer on another surface of the proton exchange membrane;
a first plate on which fuel channels for supplying a fuel are formed; and
a second plate on which (a) oxidant channels for supplying an oxidant and (b) ribs are formed, the second plate and the first plate sandwiching the cell unit in such a manner that the oxidant channels and the ribs face the cathode catalyst layer and the fuel channels face the anode catalyst layer,
wherein a gas diffusion layer and an intermediate water retentive layer that contains an ion exchanger are interposed between the cathode catalyst layer and the second plate, the intermediate water retentive layer being positioned closer to the cathode catalyst layer than the gas diffusion layer, and
the intermediate water retentive layer is constructed in such a manner that water retentivity is higher in parts facing the oxidant channels than in parts facing the ribs.

14. The fuel cell of claim 13,
wherein the intermediate water retentive layer is provided in a predetermined region extending from an oxidant inlet end toward an oxidant outlet side.

15. The fuel cell of claim 14,
wherein a size of the predetermined region is in a range of 10% to 90% inclusive of a size of an entire region extending from the oxidant inlet side end of the gas diffusion layer to an oxidant outlet side end thereof.

16. The fuel cell of any of claims 13 to 15,
wherein the intermediate water retentive layer contains a larger amount of the ion exchanger in the parts facing the oxidant channels than in the parts facing the ribs.

17. The fuel cell of any of claims 13 to 15,
wherein in the intermediate water retentive layer, an ion exchanger that is used in the parts facing the oxidant channels has a larger ion-exchange capacity than an ion exchanger that is used in the parts facing the ribs.

18. The fuel cell of any of claims 13 to 15,
wherein the ion exchanger is selected from the group consisting of a perfluoro carbon sulfonic acid, a polystyrene sulfonic acid, a polybenzimidazole sulfonic acid, and a polyether ketone sulfonic acid.

19. The fuel cell of any of claims 13 to 15,
wherein in the intermediate water retentive layer, an amount of the ion exchanger contained in the parts facing the oxidant channels is in a range of 0.02 mg/cm² to 0.12 mg/cm² inclusive.
